(19) United States
(12) Patent Application Publication
(10) Pub. No.: US 2025/0093111 A1
(43) Pub. Date: Mar. 20, 2025

(54) HEAT DISSIPATION DEVICES FOR CHANNEL COOLING SECTION AND APPLICATION METHODS THEREOF

(71) Applicant: CAIHONG DISPLAY DEVICES CO., LTD., Xianyang (CN)

(72) Inventors: Menglong WANG, Xianyang (CN); Wei YANG, Xianyang (CN); Jian XU, Xianyang (CN)

(73) Assignee: CAIHONG DISPLAY DEVICES CO., LTD., Xianyang (CN)

(21) Appl. No.: 18/970,801

(22) Filed: Dec. 5, 2024

Related U.S. Application Data
(63) Continuation-in-part of application No. PCT/CN2024/092915, filed on May 13, 2024.

(30) Foreign Application Priority Data
Sep. 4, 2023 (CN) 202311136391.5

(51) Int. Cl. F28F 3/02; B25J 9/16; F28F 21/08

(52) U.S. Cl. CPC F28F 3/02; B25J 9/163; B25J 9/1653; F28F 21/083; F28F 21/084; F28F 2280/00

(57) ABSTRACT

The present disclosure provides an embodiment of a heat dissipation device for a channel cooling section and an application method, belonging to a field of substrate glass manufacturing technology. The device includes a side refractory brick, a top refractory brick, a bottom supporting refractory brick, and at least one heat sink. The side refractory brick includes a first side refractory brick and a second side refractory brick. The first side refractory brick and the second side refractory brick are arranged opposite to each other. The top refractory brick is spliced above the first side refractory brick and the second side refractory brick, while the bottom supporting refractory brick is spliced below the first side refractory brick and the second side refractory brick. A cavity structure is formed after the splicing is completed. The first side refractory brick, the second side refractory brick, and the top refractory brick are arranged with a plurality of heat dissipation gaps, and at least one of these gaps is installed with the at least one heat sink. The present disclosure can effectively enhance the heat dissipation efficiency of the channel cooling section and is flexible, controllable, and can be used on a large scale.

### CROSS-REFERENCE TO RELATED APPLICATIONS

This application is a Continuation-in-part of International Application No. PCT/CN2024/092915, filed on May 13, 2024, which claims priority to Chinese Patent Application No. 202311136391.5, filed on Sep. 4, 2023, and the contents of which are hereby incorporated by reference.

### TECHNICAL FIELD

The present disclosure relates to a technical field of substrate glass manufacturing, and specifically relates to a heat dissipation device for a channel cooling section and an application method.

### BACKGROUND

The development of display industry has led to technological advances in the substrate glass industry, and the current substrate glass technology is mainly focused on a large lead-out volume of high-generation products and other glass used for OLED display. The increase in lead-out volume indicates that a structural function of the equipment needs to be further improved, and at the same time there are certain technical difficulties in some areas. When designing the channel cooling section, it is necessary to consider a distribution of the temperature gradient of the cross-section heat dissipation, and it is also necessary to consider many issues such as the heat dissipation structure and length design of the cooling section. At present, the length of the cooling section has reached 4 m to 5 m, and if there is a need to further increase the length, which may involve manufacturing and processing, installation, security support, and other aspects of the problem.

Adjustment of the cooling capacity of the existing cooling structure is mainly realized by adjusting a thickness of the insulation brick. In the current cooling section structure for lead-out volumes of 20 t/d or more, the thickness of external insulation brick has already been reduced to 8 mm, and several regions have been directly removed, leading to limited space for further optimization. Referring to the water-cooled panel solution occasionally used in emergencies in other regions of the channel, the process is a localized method of rapid cooling, which has high requirements for thermal shock resistance of the internal brick structure and has too strong a localized rapid cooling effect that can excessively affect the temperature of the internal glass, thus generally not supporting large area use.

Therefore, it is necessary to consider a completely new heat dissipation structure, which can increase the heat dissipation capacity as much as possible in the limited space while keeping the internal structure unchanged, and ensure the stability and safety of the structure.

### SUMMARY

In response to the existence of the prior art, the heat dissipation structure has a high requirement for the thermal shock resistance of the internal brick structure, and at the same time, the localized rapid cooling effect is too strong, which may significantly affect the temperature of the internal glass, thereby limiting the use of the existing heat dissipation structure on a large scale. Aiming at the problems, the present disclosure provides a heat dissipation device for a channel cooling section and an application method, which is capable of effectively enhancing the cooling efficiency of the cooling section and realizing flexible and controllable operation, and can be used in a large area.

In order to realize the above purposes, the present disclosure provides the following technical solution.

One or more embodiments of the present disclosure may include a heat dissipation device for a channel cooling section. The heat dissipation device may include a side refractory brick, a top refractory brick, a bottom supporting refractory brick, and at least one heat sink. The side refractory brick may consist of a first side refractory brick and a second side refractory brick. The first side refractory brick and the second side refractory brick may be arranged opposite to each other, the top refractory brick may be spliced above the first side refractory brick and the second side refractory brick, the bottom supporting refractory brick may be spliced below the first side refractory brick and the second side refractory brick, and a cavity structure may be formed after the splicing is completed. The first side refractory brick, the second side refractory brick, and the top refractory brick may be arranged with a plurality of heat dissipation gaps, and at least one of the plurality of heat dissipation gaps may be installed with the at least one heat sink.

One or more embodiments of the present disclosure may provide a method for using a heat dissipation device for a channel cooling section may include the following operations: The installed quantities of side refractory bricks, top refractory bricks, and bottom supporting refractory bricks may be determined. Based on the installed quantities, the side refractory bricks, top refractory bricks, and bottom supporting refractory bricks may be assembled to form a cavity structure.

At least one heat sink may be installed in one or more of the heat dissipation gaps created between the side refractory bricks and the top refractory bricks.

The beneficial effects brought about by the above present disclosure include, but are not limited to: (1) based on an unchanged volume of the brick, increasing the heat dissipation gap, enlarging the heat dissipation area, and matching with heat sinks to further enhance the heat dissipation capacity; the count and distribution of heat sinks can also be selected and matched according to process needs to meet the adjusting requirements under different lead-out volume. The above structure is able to effectively improve the cooling efficiency of the cooling section while achieving flexibility and control; (2) installing heat sinks on the heat dissipation gap of the brick body, which can ensure that the main structure of the cooling section does not undergo significant changes while effectively improving its overall heat dissipation capacity, and the designed side and top detachable heat sink components can be laid out and installed according to different lead-out volume needs and the purpose of segmented process adjustment; (3) fixing the side refractory bricks, top refractory bricks, and bottom supporting refractory bricks by splicing, thereby reducing the requirement for thermal shock resistance of the internal brick structure; (4) increasing or decreasing the heat sinks according to operational needs, which can avoid generating a localized rapid cooling effect that is too strong, reducing the excessive impact on the internal glass temperature, and allowing for large area use.

### BRIEF DESCRIPTION OF THE DRAWINGS

The present disclosure is further described in terms of exemplary embodiments. These exemplary embodiments are described in detail with reference to the drawings. Additionally, the shapes and proportions of various components in the drawings are merely schematic and intended to assist in the understanding of the present disclosure, and are not intended to specifically limit the shapes and proportions of the present disclosure's components, wherein:

FIG. 1 is a schematic diagram illustrating a refractory brick assembly structure of a heat dissipation device for a channel cooling section according to some embodiments of the present disclosure;

FIG. 2 is a schematic diagram illustrating a side refractory brick of a heat dissipation device for a channel cooling section according to some embodiments of the present disclosure;

FIG. 3 is a schematic diagram illustrating a side refractory brick with a stopper of A heat dissipation device for a channel cooling section according to some embodiments of the present disclosure;

FIG. 4 is a schematic diagram illustrating a top refractory brick of a heat dissipation device for a channel cooling section according to some embodiments of the present disclosure;

FIG. 5 is a schematic diagram illustrating a top refractory brick with aperture according to some embodiments of the present disclosure;

FIG. 6 is a schematic diagram illustrating a heat sink of a heat dissipation device for a channel cooling section according to some embodiments of the present disclosure;

FIG. 7 is a schematic diagram illustrating a top heat sink with a protruding structure according to some embodiments of the present disclosure;

FIG. 8 is an assembly effect diagram illustrating a heat dissipation device for a channel cooling section according to some embodiments of the present disclosure.

Description of the accompanying drawings: 11 refers to a first side refractory brick; 12 refers to a second side refractory brick; 2 refers to a top refractory brick; 3 refers to a bottom supporting refractory brick; 4 refers to a top heat dissipation piece; 51 refers to a first side heat dissipation piece; 52 refers to a second side heat dissipation piece; 6 refers to a stopper; 7 refers to a heat dissipation gap; 8 refers to a protruding structure; and 9 refers to an aperture.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It should be noted that when a component is said to be “set on” another component, it may either be directly on the other component or there may be a centered component. When a component is deemed to be “attached” to another component, it may be directly attached to the other component or there may be a plurality of centered components. The terms “vertical,” “horizontal” as used herein, “left,” “right,” and similar expressions are used herein for illustrative purposes only and are not meant to be exclusive embodiments.

Unless otherwise defined, all technical and scientific terms used in this article have the same meanings as those commonly understood by those skilled in the art belonging to the present disclosure. The terms used in the specification of this application are only for the purpose of describing specific embodiments and are not intended to limit the scope of this application. The term “and/or” used in this article includes any and all combinations of one or more related listed items.

The channel cooling section is an area used to progressively cool platinum tubes during production of substrate glass. In a process of producing substrate glass, the glass liquid in the platinum tube needs to be slowly cooled down to make sure that the glass liquid is at a suitable temperature after the glass liquid in the platinum tube is melted at a high temperature. Therefore, it is necessary to be cooled down step by step in the channel cooling section.

The channel cooling section heat dissipator is a device that improves the efficiency of heat dissipation in the channel cooling section. The heat dissipation device for the channel cooling section is a device that efficiently disperses heat in the channel cooling section and maintains an ideal cooling rate to reduce the temperature of the platinum tube in the channel cooling section as needed.

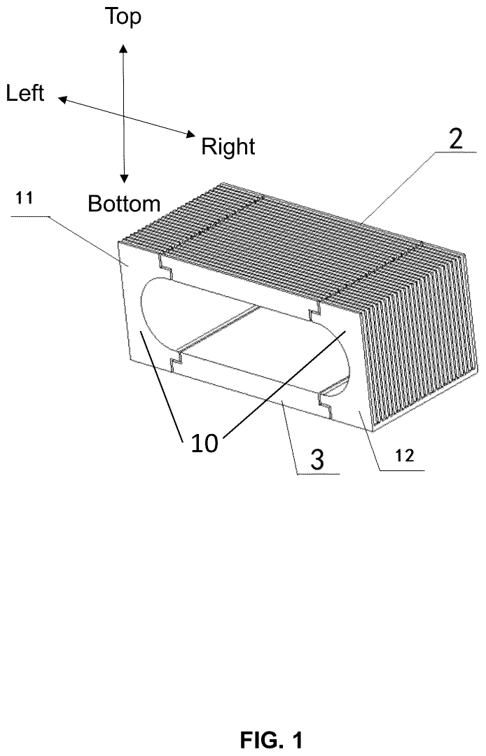

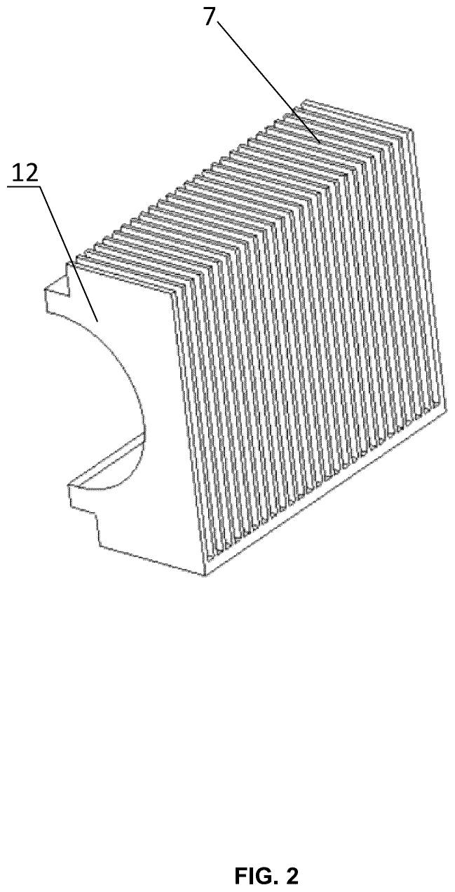

FIG. 1 is a schematic diagram illustrating a refractory brick assembly structure of a heat dissipation device for a channel cooling section according to some embodiments of the present disclosure. FIG. 2 is a schematic diagram illustrating a side refractory brick of a heat dissipation device for a channel cooling section according to some embodiments of the present disclosure.

In some embodiments, the heat dissipation device for the channel cooling section includes a refractory brick and a heat sink. As shown in FIG. 1, the refractory bricks of the heat dissipation device for the channel cooling section include a side refractory brick 10, a top refractory brick 20, and a bottom supporting refractory brick 30. The side refractory brick 10 includes a first side refractory brick 11 and a second side refractory brick 12. A plurality of heat dissipation gaps 7 are arranged on the first side refractory brick 11, the second side refractory bricks 12 and the top refractory brick 2 (refer to FIG. 2), and at least one heat sink (not shown in FIG. 1) is mounted in at least one of the plurality of heat dissipation gaps 7.

The refractory bricks are brick materials capable of retaining the structural integrity under a high temperature.

In some embodiments, two end faces of the top refractory brick 2 and the bottom supporting refractory brick 3 may be connected to an end face of the first side refractory brick 11 and an end face of the second side refractory brick 12, respectively, to form a three-dimensional shape surrounded by the four sides. An interior of the three-dimensional shape forms a cavity structure, which can be used to accommodate a platinum tube for conveying the molten glass liquid.

In some embodiments, as shown in FIG. 1, the bottom supporting refractory brick 3 is arranged below a cavity structure, the top refractory brick 2 is arranged above the cavity structure, and the first side refractory brick 11 and the second side refractory brick 12 is arranged opposite each other in a middle of the top refractory brick 2 and the bottom supporting refractory brick 3, i.e., the first side refractory brick 11 and the second side refractory brick 12 is arranged on left and right sides of the cavity structure, respectively.

In some embodiments of the present disclosure, inner surfaces of the first side refractory bricks 11 and the second side refractory bricks 12 may be in a variety of structural forms. For example, the inner surfaces of the first side refractory bricks 11 and the second side refractory bricks 12 may be planar.

In some embodiments, as shown in FIG. 2, the inner surfaces of the first side refractory bricks 11 and the second side refractory bricks 12 may be curved.

In some embodiments of the present disclosure, by designing the inner surfaces of the first side refractory bricks and the second side refractory bricks as curved shapes, the stress concentration effect of the refractory bricks can be helped to reduce, and the mechanical strength and thermal stability of the refractory bricks can be enhanced, and service life of the heat dissipation device for the channel cooling section can be improved.

In some embodiments, an inner curved surface the side refractory brick 10, as shown in FIG. 2, have synchronously designed according to a side surface structure of the cooling flat tube and retaining a certain amount of cushioning space for the filler material, wherein a diameter is controlled to be between 220 mm and 240 mm, and the external contour is a rectangular structure, a cross-section width is 100 mm to 150 mm, a height is 300 mm to 330 mm, and a length is consistent with an internal heater single module length between 300 mm and 450 mm.

In some embodiments, the inner curved surface of the side refractory brick 10 may further be a diameter range of 210 mm to 220 mm, 215 mm to 225 mm, 220 mm to 230 mm, 225 mm to 235 mm, 230 mm to 240 mm, 235 mm to 245 mm, 240 mm to 250 mm; the cross-section width of the outer profile may also be at least one of 90 mm to 110 mm, 100 mm to 120 mm, 110 mm to 130 mm, 120 mm to 140 mm, 130 mm to 150 mm, 140 mm to 160 mm; the height may further be at least one of 290 mm to 310 mm, 300 mm to 320 mm, 310 mm to 330 mm, 320 mm to 340 mm, and the length may further be at least one of 290 mm to 330 mm, 310 mm to 350 mm, 330 mm to 370 mm, 350 mm to 390 mm, 370 mm to 410 mm, 390 mm to 430 mm, 410 mm to 450 mm, and 430 mm to 460 mm.

In some embodiments, the inner curved surface of the side refractory brick 10 may further be a diameter of at least one of 210 mm, 215 mm, 220 mm, 225 mm, 230 mm, 235 mm, 240 mm, 245 mm, 250 mm; the cross-section width of the outer contour may also be at least one of 90 mm, 100 mm, 110 mm, 120 mm, 130 mm, 140 mm, 150 mm, 160 mm; the height may further be at least one of 290 mm, 300 mm, 310 mm, 320 mm, 330 mm, 340 mm; the length may further be at least one of 290 mm, 310 mm, 330 mm, 350 mm, 370 mm, 390 mm, 410 mm, 430 mm, 450 mm, 460 mm.

In some embodiments, outer sides of the first side refractory brick and the second side refractory brick are provided with a stopper, respectively.

During a production process of the substrate glass, the heat dissipation device for the channel cooling section may sway, at which time the heat dissipation gap may not be able to hold the heat sink, resulting in the tipping of the side heat sink. Therefore, the stopper may be provided on the outer side of the side refractory brick.

In some embodiments, the stopper may include a variety of shapes. For example, the stopper may be rectangular, triangular, or the like. To ensure the anti-tipping effect of the stopper, the stopper is provided at a side of the refractory brick away from the outer side of the cavity structure.

In some embodiments, the stopper and the side refractory brick together may form an anti-tipping step for preventing the side heat sink 51 and 52 from tipping.

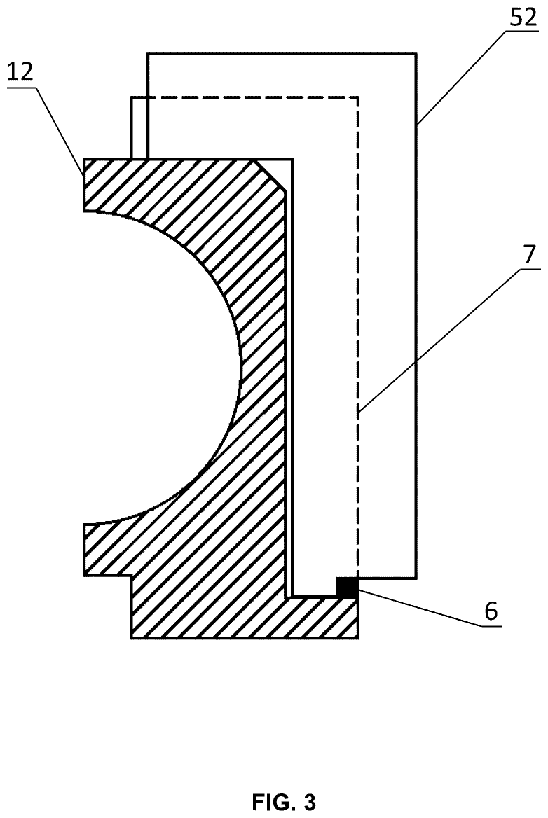

FIG. 3 is a schematic diagram illustrating a side refractory brick with a stopper of a heat dissipation device for a channel cooling section according to some embodiments of the present disclosure. As shown in FIG. 3, taking only the second side refractory brick 12 as an example, the outer sider of the second side refractory brick 12 is provided with a rectangular stopper 6 to form an “L” shape anti-tipping step, which can ensure that the second side heat sink 52 is difficult to tip over after the second side heat sink 52 is inserted into the heat dissipation gap 7.

In some embodiments of the present disclosure, an “L”-shaped anti-tipping step is formed by providing the stopper on the sides of the first side refractory brick and the second side refractory brick, which can effectively increase the stability between the heat sink and the refractory brick, preventing the heat sink from tilting or collapsing due to external force, vibration or temperature change, thereby ensuring the safety and heat dissipation efficiency of the equipment.

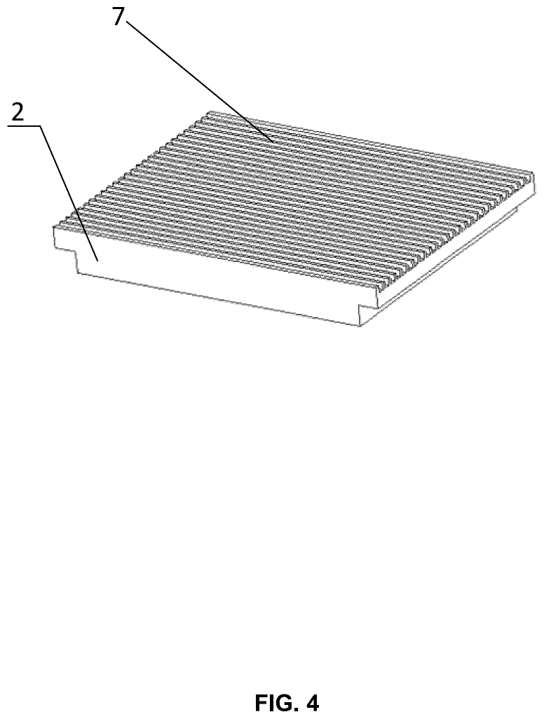

FIG. 4 is a schematic diagram illustrating a top refractory brick of a heat dissipation device for a channel cooling section according to some embodiments of the present disclosure. In some embodiments, the interior of the top refractory brick 2, as shown in FIG. 4, is a planar structure or is considered to be of a curved structure for the upper arching scheme of the cooling flat tubes, such that a spacing of the inner surface from the body of the platinum tubes is kept in a range of 15 mm to 20 mm within a fixed range for the filling space of the filler material; the outer contour is a rectangular structure, and the width of the cross-section is in the range of 400 mm to 600 mm, the thickness is designed to be 50 mm, and the length is consistent with the length of the internal heater individual modules between 300 mm to 450 mm.

In some embodiments, the spacing between the inner surface of the top refractory brick 2 and the platinum tube body may further be 13 mm to 15 mm, 14 mm to 16 mm, 15 mm to 17 mm, 16 mm to 18 mm, 17 mm to 19 mm, 18 mm to 20 mm, 19 mm to 21 mm, 20 mm to 22 mm, and the cross-section width of the outer contour of the top refractory brick 2 may further be at least one of 380 mm, 400 mm, 420 mm, 440 mm, 460 mm, 480 mm, 500 mm, 520 mm, 540 mm, 560 mm, 580 mm, 600 mm, 620 mm; the thickness may further be 48 mm to 52 mm, and the length may further be at least one of 280 mm to 320 mm, 300 mm to 340 mm, 320 mm to 360 mm, 340 mm to 380 mm, 360 mm to 400 mm, 380 mm to 420 mm, 400 mm to 440 mm, 420 mm to 460 mm, and 440 mm to 470 mm.

In some embodiments, the spacing between the inner surface of the top refractory brick 2 and the platinum tube body may further be at least one of 13 mm, 14 mm, 15 mm, 16 mm, 17 mm, 18 mm, 19 mm, 20 mm, 21 mm, 22 mm; the outer contour of the top refractory brick 2 may further be at least one of 380 mm, 400 mm, 420 mm, 440 mm, 460 mm, 480 mm, 500 mm, 520 mm, 540 mm, 560 mm, 580 mm, 600 mm, 620 mm; and the thickness may further be at least one of 48 mm, 49 mm, 50 mm, 51 mm, 52 mm; the length may further be at least one of 280 mm, 300 mm, 320 mm, 340 mm, 360 mm, 380 mm, 400 mm, 420 mm, 440 mm, 460 mm, 470 mm.

In some embodiments, as shown in FIG. 1, the refractory brick structure includes the side refractory brick 10, the top refractory brick 2, and the bottom supporting refractory brick 3, which are spliced together using an overlapping scheme.

In some embodiments of the present disclosure, the splicing is used to hold the side refractory brick, the top refractory brick, and the bottom supporting refractory brick in place, thus reducing the requirement for thermal shock resistance of the internal brick structure.

In some embodiments of the present disclosure, the refractory bricks are made from a high temperature resistant material, such as one or more of alumina, silica, iron oxide, magnesium oxide, zirconia, chromium oxide, or the like.

In some embodiments of the present disclosure, the materials of the side refractory brick, the top refractory brick 2, and the bottom supporting refractory brick 3 are made of a-alumina bricks, the Al₂O₃ content is greater than or equal to 95%.

In some embodiments of the present disclosure, adopting a-alumina as the material of the refractory bricks can enhance the heat and corrosion resistance of the refractory bricks and ensure the reliability of the heat dissipation device for the channel cooling section in a high temperature environment.

In some embodiments of the present disclosure, the first side refractory brick 11, the second side refractory brick 12, and the top refractory brick 2 are lined with a number of heat dissipation gaps, in which the heat sinks are installed.

The heat dissipation gap of the refractory brick is a gap or recess in the surface of the refractory brick for mounting a heat sink. In some embodiments of the present disclosure, the heat dissipation gap of the refractory brick may be distributed in a variety of ways, e.g., the heat dissipation gap may be distributed parallel to the platinum tube. As another example, the heat dissipation gap may be distributed perpendicular to the platinum tube.

In some embodiments of the present disclosure, there are various options for a gap width and gap spacing of the heat dissipation gaps provided on the first side refractory brick 11, the second side refractory brick 12, and the top refractory brick 2.

The gap width refers to a width for a single heat dissipation gap. The gap spacing refers to a distance between two neighboring heat dissipation gaps.

In some embodiments of the present disclosure, the gap width of the heat dissipation gap and the gap spacing may be determined based on actual application scenarios and needs. For example, the gap width of the heat dissipation gap may be the heat sink thickness to ensure that the heat sink can be securely fixed to the refractory brick.

In some embodiments of the present disclosure, by flexibly setting the gap width and gap spacing of the refractory brick heat dissipation gaps and adjusting the gap width and the gap spacing according to the actual heat dissipation demand, the ubiquity of the heat dissipation device for the channel cooling section can be enhanced.

In some embodiments of the present disclosure, an aperture 9 is provided in outer surfaces of the first side refractory brick 11, the second side refractory brick 12, and the top refractory brick 2.

The aperture refers to a void or hole opened in the surface of a refractory brick, and the protruding structure of the heat sink may be inserted into the aperture of the refractory brick. In some embodiments of the present disclosure, the aperture is provided in the heat dissipation gap of the refractory bricks, and the aperture may partially penetrate the refractory brick or penetrate an inner and outer surface of the refractory brick.

In some embodiments of the present disclosure, the count of apertures of the refractory brick may be one or more. The count of apertures may be determined based on actual application scenarios and needs.

In some embodiments of the present disclosure, the apertures in the refractory bricks may be distributed in a variety of ways. For example, the apertures are randomly distributed across a surface of the refractory brick. As another example, the apertures may be distributed in a grid pattern.

In some embodiments of the present disclosure, the apertures may be distributed in a straight line. For example, the apertures may be distributed at the bottom of the heat dissipation gap. That is to say, at least one aperture is arranged within each heat dissipation gap. The count and distribution of apertures corresponding to each heat dissipation gap may be preset based on a priori experience.

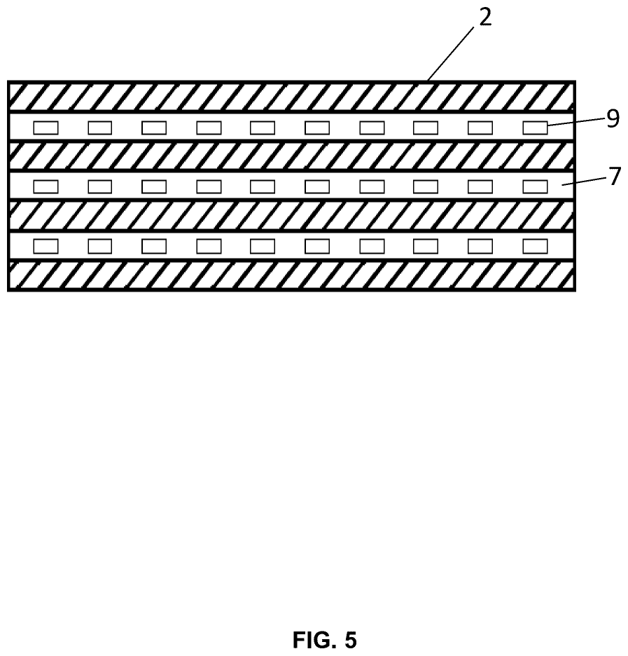

FIG. 5 is a schematic diagram illustrating a top refractory brick with aperture according to some embodiments of the present disclosure.

In some embodiments of the present disclosure, the top refractory brick structure as shown in FIG. 5 may be formed when the aperture 9 is distributed in a grid-like pattern within the heat dissipation gap 7 of the top refractory brick 2.

The heat sinks are devices used to improve the efficiency of heat dissipation, and the heat sinks may be covered on an outer surface of the refractory brick.

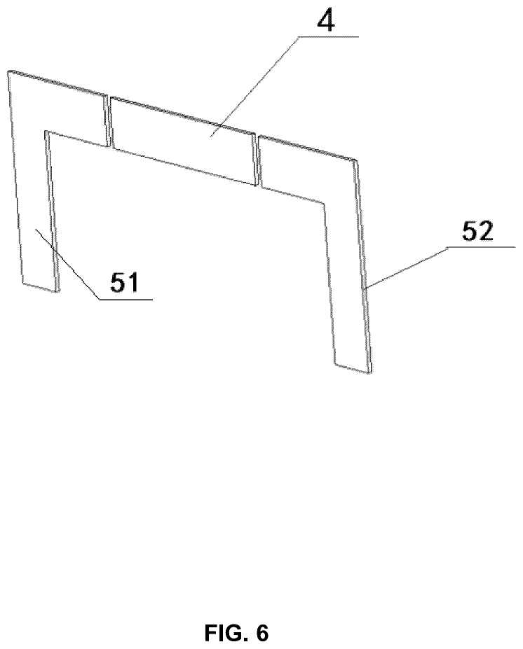

FIG. 6 is a schematic diagram illustrating a heat sink of a heat dissipation device for a channel cooling section according to some embodiments of the present disclosure.

In some embodiments of the present disclosure, the heat sink includes a top heat sink 4, a first side heat sink 51, and a second side heat sink 52.

In some embodiments of the present disclosure, the first side heat sink 51 is arranged in a heat dissipation gap of the first side refractory brick 11, the second side heat sink 52 is arranged in a heat dissipation gap of the second side refractory brick 12, and the top heat sink 4 is arranged in a heat dissipation gap of the top refractory brick 2.

In some embodiments of the present disclosure, placing different heat sinks in the heat dissipation gaps of the corresponding refractory bricks may be targeted to optimize heat dissipation of different refractory bricks.

In some embodiments of the present disclosure, the heat sink is made of a material with high thermal conductivity, such as a single metal or alloy of iron, aluminum, copper, platinum, magnesium, or the like.

In some embodiments of the present disclosure, the top heat sink 4, the first side heat sink 51, and the second side heat sink 52 is made of stainless steel.

In some embodiments of the present disclosure, the use of stainless steel as the material of the heat sink can ensure, through lower cost, that the heat sink can resist oxidation and corrosion while having sufficient mechanical strength, which can help to ensure the service life of the heat dissipation device for the channel cooling section in harsh environments.

In some embodiments, the heat sink may include multiple shapes. For example, the heat sink may be in a form of a sheet, and multiple sheet-like heat sinks are arranged at intervals to form a fin-like heat dissipation structure. As another example, the heat sink may be a columnar structure, a honeycomb structure, or the like.

In some embodiments, as shown in FIG. 6, the top heat sink 4 is rectangular, and the first side heat sink 51 and the second side heat sink 52 are in an “L” shape.

In some embodiments in the present disclosure, designing the first side heat sink 51 and the second side heat sink 52 as an L-shape helps to increase the surface area of the heat sinks and to provide better heat dissipation, thereby improving the heat dissipation efficiency; and designing the top heat sink as a rectangular shape can maximize the use of the top space and facilitate manufacturing and installation to enhance the heat dissipation effect.

In some embodiments, the bottom supporting refractory brick 3 have the same profile as the top refractory brick 2, and considering the structural support of the bottom supporting refractory brick 3, the bottom supporting refractory brick 3 is not provided with a heat sink in the heat dissipation gap.

In some embodiments, the side refractory brick, the top refractory brick 2, and the bottom supporting refractory brick 3 are lined with heat dissipation structures, which adopts a multi-sheet distribution, a thickness of the single heat sink is 10 mm, a thickness of the heat dissipation gap is 15 mm, and a depth of the heat sink is generally in 25 mm, the count of heat sinks depend on the length of the refractory bricks, different length are distributed with different count of heat sinks, and with the current structural dimensions, using only the refractory material structure for heat dissipation has increased the heat dissipation area by nearly 2 to 3 times.

In some embodiments, the heat sinks, as shown in FIG. 6, are mainly divided into two types, the top heat sink 4 and the side heat sink, both of which have a thickness of 8 mm; the top heat sink 4, which is shaped as a rectangular sheet structure, is about 10 mm smaller in width than both ends of the top refractory brick 2, facilitating installation and removal with an insertion depth of 25 mm, which is consistent with the heat dissipation gap depth on the refractory brick; the side heat sink, shaped like an inverted “L” shaped, has the same width as the top heat sink 4, and the insertion depth is also the same as that of the top heat sink.

In some embodiments, lower ends of the first side heat sink 51, the second side heat sink 52, and the top heat sink are provided with a protruding structure 8 to be inserted into the aperture 9 of the heat dissipation gap 7. The lower end of the heat sink is an end of the heat sink configured to be inserted into the refractory brick.

The protruding structure is a structure for inserting an aperture in the refractory brick. In some embodiments, the structural form of the protruding structure includes a cylindrical shape, a square shape, a conical shape, a spiral shape, or the like. The shape and size of the protruding structure of the heat sink matches the apertures of the refractory bricks to ensure that the protruding structure of the heat sink may be securely inserted into the apertures of the refractory bricks.

In some embodiments, the count and distribution of protruding structures at the lower end of the heat sink may be determined based on specific heat dissipation needs. For example, the count and distribution of the protruding structures of the heat sink may match the count and distribution of the apertures of the corresponding refractory bricks. The count and distribution of the protruding structures of the first side heat sink 51 matches the count and distribution of the apertures of the first side refractory bricks 11; the count and distribution of the protruding structures of the second side heat sink 52 matches the count and distribution of the apertures of the second side refractory bricks 12; and the count and distribution of the protruding structures of the top heat sink 4 matches the count and distribution of apertures of the top refractory brick 2.

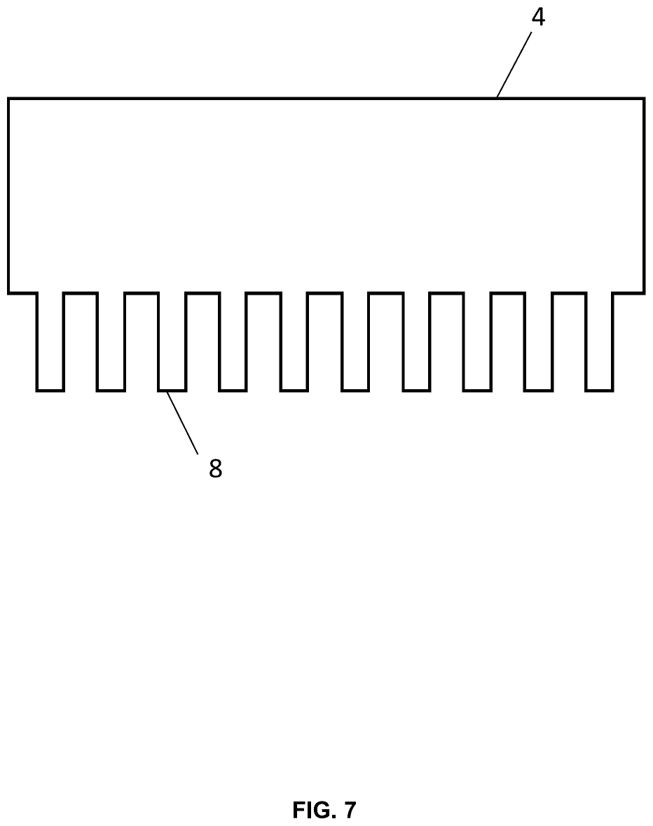

FIG. 7 is a schematic diagram illustrating a top heat sink with a protruding structure according to some embodiments of the present disclosure.

In some embodiments, the lower end of the top heat sink 4 is provided with a protruding structure 8, as shown in FIG. 7, and the count and distribution of the protruding structure 8 shown in FIG. 7 matches the count and distribution of the apertures 9 of the top refractory brick 2 shown in FIG. 5.

In some embodiments in the present disclosure, by providing apertures on the surfaces of the refractory bricks and matching-sized apertures on the corresponding heat sinks, the fixing stability between the heat sinks and the refractory bricks can be enhanced, which can also prevent the heat sinks from becoming loose or detaching due to thermal expansion or vibration. At the same time, it is possible to increase the contact area between the heat sink and the refractory brick and improve the heat transfer efficiency between the heat sink and the refractory brick, and thus to improve the heat dissipation effect of the heat dissipation device for the channel cooling section.

In some embodiments in the present disclosure, the assembly of the first side refractory brick 11, the second side refractory brick 12, the top refractory brick 2, and the bottom supporting refractory brick 3 is accomplished by using lap splicing, and after the splicing is accomplished, the cavity structure is formed internally, and the cavity is used to accommodate the platinum tube. To prevent issues such as internal “red leakage,” heat dissipation gaps are provided on the outer surfaces of the first side refractory brick 11, the second side refractory brick 12, and the top refractory brick 2. This allows for an increase in heat dissipation gaps and an expansion of the heat dissipation area without altering the volume of the bricks.

In some embodiments in the present disclosure, by opening heat dissipation gaps in the brick body and installing heat sinks, the overall heat dissipation capability of the cooling section can be effectively enhanced without significant changes to the main structure. The designed removable side and top heat sink components can be positioned and installed according to varying lead-out volume requirements and the objectives of process segmentation adjustments, allowing for flexibility in the arrangement and quantity of the heat sinks.

In some embodiments, a method of using a heat dissipation device for the channel cooling section includes: determining an installed quantity of the first side refractory brick 11, the second side refractory brick 12, the top refractory brick 2, and the bottom supporting refractory brick 3; assembling, according to the installed quantity, the first side refractory brick 11, the second side refractory brick 12, the top refractory brick 2, and the bottom supporting refractory brick 3 to form a cavity structure; and installing a heat sink in a heat dissipation gap on the first side refractory brick 11, the second side refractory brick 12, and the top refractory brick 2.

In some embodiments in the present disclosure, by opening a heat dissipation gap on the brick body and installing a heat sink, it is possible to effectively improve the overall heat dissipation capability of the cooling section without ensuring that the main structure of the cooling section does not undergo large changes.

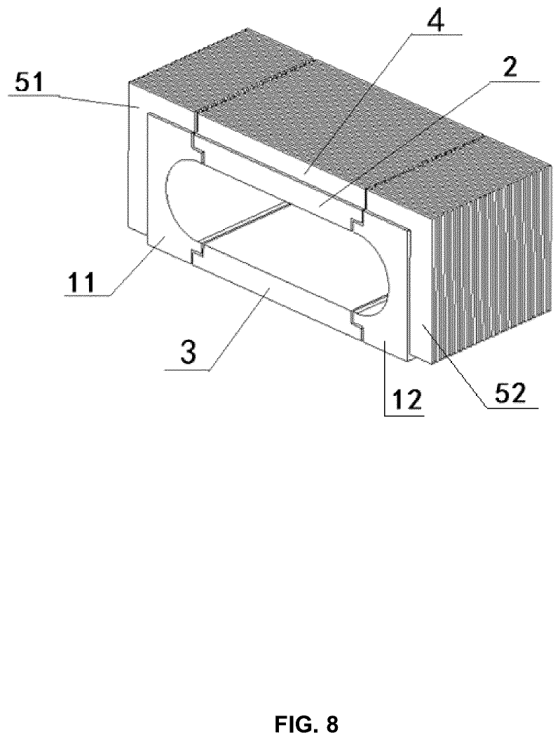

FIG. 8 is an assembly drawing illustrating a heat dissipation device for a channel cooling section according to some embodiments of the present disclosure. The heat dissipation gap is distributed perpendicular to the platinum tube (i.e., an extension direction of the heat dissipation gap is perpendicular to an extension direction of the channel cooling section), the structure shown in FIG. 8 may be formed after the heat sink is installed.

In some embodiments, the heat dissipation device for the channel cooling section further includes an automatic installation device.

The automatic installation devices are devices used to perform automatic mounting or dismounting of heat sinks, such as robotic arms, manipulators, or the like.

In some embodiments, determining an installed quantity of the first side refractory brick 11, the second side refractory brick 12, the top refractory brick 2, and the bottom supporting refractory brick 3 further includes: obtaining user demand data based on user input information; obtaining production data, lead-out volume data, and processing data; determining installation parameters based on the user demand data, production data, lead-out volume data, and processing data; generating installation instructions based on the installation parameters; and sending the installation instructions to an automatic installation device to control a robotic arm to install the first side refractory brick 11, the second side refractory brick 12, the top refractory brick 2, the bottom supporting refractory brick 3, and the heat sinks in corresponding positions, according to the installation parameters. The operation may be performed by a device having computing power, such as a processor mounted inside the heat dissipation device for the channel cooling section, or the like.

In some embodiments, the user demand data may include a glass liquid target temperature. The glass liquid target temperature is a glass liquid output temperature desired by the user.

In some embodiments, a glass liquid output temperature input by the user may be determined as a glass liquid target temperature.

The production data refers to data related to a production of the substrate glass. In some embodiments, the production data may include one or more of glass liquid composition data, thermal conductivity coefficient of the glass liquid, glass liquid entry temperature, or the like. The glass liquid entry temperature is a temperature of the glass liquid before it enters the heat dissipation device for the channel cooling section.

In some embodiments, the production data may be obtained in a variety of

ways. For example, the entry temperature of the glass liquid may be obtained using a temperature sensor installed at the inlet of the heat dissipation device for the channel cooling section. The composition of the glass liquid and thermal conduction coefficients of the glass liquid may be determined from documents such as production reports, production plans, and other related documents.

The lead-out volume data may reflect a consumption rate of the glass liquid. The larger the lead-out volume data is, the more glass liquid is consumed per unit of time, and the more glass liquid needs to be cooled down, the higher the heat dissipation requirements for the heat sink are. The smaller the lead-out volume data, the less glass liquid needs to be cooled down, and the lower the heat dissipation requirements for the heat sink.

The processing data may reflect parameters associated with the production of the substrate glass. In some embodiments, the processing data includes a thickness and size of the substrate glass, a production cycle of the production line, or the like. The production cycle includes continuous production, intermittent production, or the like.

The installation parameters may reflect parameters related to the heat sink to be mounted on the heat dissipation device for the channel cooling section. In some embodiments, the installation parameters include a first installation parameter and a second installation parameter. The first installation parameter includes an installed quantity of refractory bricks. The second installation parameter includes a heat sink installed quantity and a heat sink installation distribution.

The mounting distribution of the heat sinks may reflect a presence or absence of heat sinks mounted on the heat dissipation gap of the refractory brick. The second installation parameter may be represented by a sequence. For example, (0,1,1) indicates that no heat sink is installed on the first heat dissipation gap, one heat sink is installed on the second heat dissipation gap, and one heat sink is installed on the third heat dissipation gap.

In some embodiments, the first installation parameter further includes a width of the heat dissipation gap, a spacing of the heat dissipation gap, and a count of apertures of the first side refractory brick 11, the second side refractory brick 12, and the top refractory brick 2; and the second installation parameter further includes a heat sink thickness, heat sink type. The heat sinks with the same count and distribution of protruding structures may be grouped in the same category. The processor may assign corresponding serial numbers to each class of heat sinks, such as heat sinks in Class A, heat sinks in Class B, or the like. At this point, the second installation parameter may be represented as a sequence with the heat sink thickness and the heat sink type. For example, ({0,0}, {10 mm, A}, {15 mm, B}) indicate that no heat sink is installed on the first heat dissipation gap, a heat sink with the thickness of 10 mm and in Class A is installed on the second heat dissipation gap, and a heat sink with the thickness of 15 mm and in Class B is installed on the third heat dissipation gap.

In some embodiments of the present disclosure, by broadening the types of data for the first installation parameter and the second installation parameter, the influence of more data can be taken into account in the subsequent vector matching process, which helps to improve the accuracy and reliability of the predicted installation parameters.

In some embodiments, the processor may construct a production feature vector based on the user demand, the processing data, the production data, and the lead-out volume data, and query a vector database based on the production feature vector to determine the installation parameters.

The production feature vector is a vector based on the composition of user demand, processing data, production data, and lead-out volume data. For example, the production feature vector may be represented as (X₀, Y₀, Z₀, T₀), wherein X₀ denotes user demand, Y₀ denotes processing data, Z₀ denotes production data, and T₀ denotes lead-out volume data.

The vector database includes multiple reference vectors, each of which has a corresponding reference installation parameter.

In some embodiments, the processor may obtain multiple large amounts of information such as historical user demand, historical processing data, historical production data, and historical lead-out volume data through the history of successful production of the substrate glass (i.e., a history of the subsequent quality inspection process in which no defects were found in the substrate glass), and thereby construct multiple reference vectors; obtain the historical installation parameters at the historical moment when the substrate glass is produced as the reference installation parameters corresponding to the reference vectors; and ultimately save the multiple production feature vectors and the corresponding reference installation parameters as a vector database.

In some embodiments, the processor may separately perform a similarity matching based on the production feature vectors with a plurality of reference vectors in the vector database, select a reference vector whose similarity satisfies a preset condition, and use the reference installation parameters corresponding to the reference vector as the current required installation parameters. The preset condition may be that the similarity is greater than a preset threshold, or the similarity is maximum, or the like. The similarity matching manner includes but is not limited to a manhattan distance manner, a support vector machine (SVM) manner, or the like.

In some embodiments in the present disclosure, a plurality of candidate installation parameters are determined by a heat dissipation feature model, and the most suitable mounting solution is selected from the candidates based on the user demand, which helps maximize heat dissipation and ensures stable operation of the device.

In some embodiments, the user demand data further include a heat dissipation temperature gradient; and the determining the installation parameters further includes: obtaining a plurality of candidate installation parameters; based on the candidate installation parameters, the processing data, the production data, the heat dissipation parameters of the heat sinks, and the production environment data, using a heat dissipation feature determination model to determine a heat dissipation feature sequence corresponding to each candidate installation parameter; based on the heat dissipation feature sequence, user demand data, from the plurality of candidate installation parameters, determining the installation parameters.

The heat dissipation temperature gradient is a maximum temperature difference allowed at different locations within a cooling section. For example, the heat dissipation temperature gradient may be 5° C./m, indicating that the glass liquid is required to drop in temperature by up to 5° C. as it advances 1 meter within the cooling section.

The candidate installation parameters are installation parameters to be selected. In some embodiments, the processor may generate the candidate installation parameters in multiple ways. For example, the candidate installation parameters may be randomly generated. As another example, the processor may use a reference installation parameter in the vector database that has a similarity to the production feature vector greater than a preset threshold as a candidate installation parameter. More descriptions of the similarity may be found above.

The heat dissipation parameters of the heat sink may include the thermal conductivity and total surface area of the heat sink. The production environment data may include ambient temperature, ambient humidity, or the like.

In some embodiments, the processor may obtain the production environment data via an environmental monitoring device (e.g., thermometer, hygrometer, etc.). The processor may obtain information such as a factory report of the heat sink to get the heat dissipation parameters of the heat sink.

The heat dissipation feature sequence may reflect changes in the heat dissipation feature data over time. The heat dissipation feature data may include a glass liquid output temperature, temperature distribution data, cooling rate data, or the like. The temperature distribution data may reflect a temperature of the glass liquid at different locations within the cooling section, and the cooling speed data may reflect a cooling speed of the glass liquid at different locations within the cooling section.

The heat dissipation feature determination model is a model for determining a heat dissipation feature sequence corresponding to each candidate parameter. In some embodiments, the heat dissipation feature determination model may be a machine learning model. For example, the heat dissipation feature determination model may include a combination of one or more of a neural network (NN) model or other customized model.

In some embodiments, inputs of the heat dissipation determination model may include: the candidate installation parameters, the processing data, the production data, the lead-out volume data, heat dissipation parameters of the heat sink, the production environment data. outputs of the heat dissipation determination model may include a heat dissipation feature sequence corresponding to each set of candidate installation parameters.

In some embodiments, the heat dissipation feature determination model may be obtained based on numerous first training samples trained with a first label. The first training samples may include sample candidate installation parameters, sample processing data, sample production data, sample lead-out volume data, sample heat dissipation parameters of the heat sink, sample production environment data, and the first label may include a first sequence of sample heat dissipation feature sequence corresponding to the training sample.

In some embodiments, the first training sample with the first label may be obtained based on historical temperature detection records.

In some embodiments, the processor may input a plurality of first training samples with the first label into an initial heat dissipation feature determination model, construct a loss function from the first label and results of the initial heat dissipation feature determination model, iteratively update, based on the loss function, an initial data prediction model. The model training is completed when the preset condition is satisfied, and the trained heat dissipation feature determination model is obtained. The preset condition may be that the loss function converges, the number of iterations reaches a threshold, or the like.

In some embodiments, the processor may reject candidate installation parameters that fail to meet the user demand data (e.g., glass liquid target temperature, heat dissipation temperature gradient requirements) based on the sequence of heat dissipation feature data corresponding to the candidate installation parameters. After eliminating non-compliant candidate installation parameters, the processor may use the remaining candidates as installation parameters. For example, one of the remaining candidate installation parameters is randomly selected as an installation parameter. As another example, the processor may select a candidate installation parameter that installs a minimum count of heat sinks as an installation parameter.

In some embodiments, the processor may determine the installation instructions based on the installation parameters. The installation instructions may be generated based on the installation parameters and include at least the installed quantity of refractory bricks, the installed quantity of heat sinks, and the mounting distribution of the heat sinks.

In some embodiments, the processor sends an installation instruction to the automatic installation device to control the robotic arm to install the one side refractory bricks, the second side refractory bricks, the top refractory bricks, and the bottom supporting refractory bricks, and the corresponding positional heat sink in accordance with the installation parameters.

In some embodiments in the present disclosure, by introducing an automatic installation device, automatic installation or removal of heat sinks and refractory bricks can be realized, reducing manual intervention and improving production efficiency and accuracy; by selecting a candidate for installing the minimum count of heat sinks installation parameter as the installation parameter, the heat sink can be installed quickly, thereby improving the installation efficiency, so that the heat dissipation device for the channel cooling section can be put into use as soon as possible.

In some embodiments, the processor may obtain glass liquid temperature data, real-time lead-out volume based on the pipe monitoring device; determine a correction second installation parameter based on the glass liquid temperature data, the production environment data, and the real-time lead-out volume; and generate a correction instruction based on the correction second installation parameters to generate a correction instruction, send the correction instruction to the automatic installation device, and instruct the automatic installation device to control a robotic arm to complete installation or removal of a heat sink.

The pipe monitoring device is a device used to monitor changes in an internal condition of a pipeline. The pipe monitoring device may include flow meters, thermometers, or the like.

In some embodiments, the processor may obtain glass liquid temperature data and real-time lead-out volume based on the pipe monitoring device. More descriptions of the lead-out volume may be found above.

The corrected second installation parameter is an adjusted second installation parameter. In some embodiments, the corrected second installation parameter includes a count of heat sinks to be installed or removed on the refractory bricks at different locations, a position of the heat dissipation gap where the heat sinks are to be installed or removed, and the type of the heat sink to be used in the case of adding the heat sink.

In some embodiments, the processor may determine a corrected second installation parameter based on the current glass liquid temperature data, the production environment, the real-time lead-out volume, or the like.

In some embodiments, the processor may be able to increase or decrease the count of heat sinks in a variety of ways based on correcting the second installation parameter. For example, when the actual output temperature of the glass liquid does not meet the user demand, the heat sink device adjusts the count of heat sinks to meet the heat dissipation needs.

In some embodiments, when the actual output temperature of the glass liquid is too low and does not meet the user demand, the processor may control the automatic installation device to gradually decrease the count of heat sinks until the actual output temperature of the glass liquid meets the user demand; when the actual output temperature is too high and does not meet the user demand, the processor may control the automatic installation device to gradually increase the count of heat sinks until the glass liquid output temperature meets the user demand.

In some embodiments, when inserting or pulling out a heat sink with more protruding structures, the impact on the cooling capacity of the heat dissipation device for the channel cooling section is greater than when inserting or pulling out a heat sink with less protruding structures. Therefore, when the actual output temperature of the glass liquid deviates from the user demand to a larger extent (e.g., the difference between the actual output temperature and the target temperature of the glass liquid is larger than a predicted temperature threshold), the processor may give priority to inserting or pulling out the heat sink with more protruding structures, so as to make the actual output temperature of the glass liquid approaches the user demand quickly, and when the actual output temperature of the glass liquid deviates from the user demand to a lesser extent, the processor can give priority to inserting or pulling out the heat sink with fewer protruding structures to make the actual output temperature of the glass liquid approach the user demand slowly.

In some embodiments, in response to determining that there is a need to adjust the second installation parameter, the processor may determine the future heat dissipation feature sequence using a heat dissipation feature determination model. This determination is based on the actual installation parameters, actual production environment data, process data, production data, actual lead-out volume data, and the heat dissipation parameters of the heat sink. Based on the future heat dissipation feature data, the processor may adjust the second installation parameter accordingly.

In some embodiments, when the actual output temperature of the glass liquid does not meet the user demand, it may be deemed necessary to correct the second installation parameter.

The future heat dissipation feature sequence is a sequence consisting of heat dissipation feature data for a future time period.

In some embodiments, the future heat dissipation feature sequence may be determined based on a heat dissipation feature determination model. The processor may input the actual installation parameters, the actual production environment data, the processing data, the production data, the actual lead-out volume data, and the heat dissipation parameters of the heat sink at the current moment in time into the trained heat dissipation feature determination model, and the output of the model is determined as a future heat dissipation feature sequence. More descriptions of the heat dissipation feature determination model may be found in the description above.

In some embodiments, the processor may determine to correct the second installation parameter based on future heat dissipation feature data. For example, when the future heat dissipation feature data indicates that the future output temperature of the glass liquid does not meet the user demand, the processor may generate a modified second installation parameter that increases or decreases the count of heat sinks to be treated as if it were an actual installation parameter in the actual second installation parameter, input it again to the heat dissipation feature determination model, and adjust it after repeated cycles until the modified second installation parameter meets the user demand, at which time the modified second installation parameter may be determined.

In some embodiments in the present disclosure, the correction of the second installation parameter based on future heat dissipation feature data may dynamically adjust the mounting solution to ensure a more precise heat dissipation effect, and thus improve the heat dissipation efficiency and operation stability of the device.

In some embodiments, the processor may determine the installed quantity of first side refractory brick, second side refractory brick, top refractory brick, and bottom supporting refractory brick based on the thermal efficiency of the required power conversion.

In some embodiments, the processor may increase or decrease the count of the heat sinks based on the thermal conductivity need. For example, a fitting gap of the mounting slot width is 2 mm, and the installed quantity of the first side refractory brick, the second side refractory brick, the top refractory brick, and the bottom supporting refractory brick need to be extrapolated based on the thermal efficiency of the required power conversion. In this area, the corresponding temperature is about 400° C., the thermal conductivity of the corresponding heat sink is 20 W/(m·K), and the thermal conductivity of the refractory bricks is 2.5 W/(m·K), based on the calculation, according to the standard lead-out volume, 30% of the count of heat sinks need to be distributed uniformly to satisfy the requirements, and for every increase in the lead-out volume by 50 kg/h, the count of heat sinks needs to be increased by 10% until it reaches the full load of 100%, during the process, it may also be reduced according to the reduction of the lead-out volume.

In some embodiments in the present disclosure, the heat dissipation gap is increased on the basis of the unchanged volume of the bricks, the heat dissipation area is expanded, and the heat sink is matched to further enhance the heat dissipation capacity, and the count and distribution of the heat sink may also be selected and matched according to the process needs. The count and distribution of heat sinks may also be selected and matched at the right time to meet the adjustment requirements of different lead-out volume, which may effectively improve the cooling efficiency of the cooling section and realize flexible control. It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A heat dissipation device for a channel cooling section, wherein the heat dissipation device comprises a side refractory brick, a top refractory brick, a bottom supporting refractory brick, and at least one heat sink;
the side refractory brick comprises a first side refractory brick and a second side refractory brick;
the first side refractory brick and the second side refractory brick are arranged opposite to each other, the top refractory brick is spliced above the first side refractory brick and the second side refractory brick, the bottom supporting refractory brick is spliced below the first side refractory brick and the second side refractory brick, and a cavity structure is formed after the splicing is completed;
the first side refractory brick, the second side refractory brick, and the top refractory brick are arranged with a plurality of heat dissipation gaps, and at least one of the plurality of heat dissipation gaps is installed with the at least one heat sink.

2. The heat dissipation device for the channel cooling section of claim 1, wherein inner surfaces of the first side refractory brick and the second side refractory brick are curved.

3. The heat dissipation device for the channel cooling section of claim 1, wherein the side refractory brick, the top refractory brick, and the bottom supporting refractory brick are made of a-alumina, and a content of is greater than or equal to 95%.

4. The heat dissipation device for the channel cooling section of claim 1, wherein the at least one heat sink includes a top heat sink, a first side heat sink, and a second side heat sink;
the top heat sink is arranged in the heat dissipation gap of the top refractory brick;
the first side heat sink is arranged in the heat dissipation gap of the first side refractory brick; and
the second side heat sink is arranged in the heat dissipation gap of the second side refractory brick.

5. The heat dissipation device for the channel cooling section of claim 4, wherein the top heat sink, the first side heat sink, and the second side heat sink are made of stainless steel.

6. The heat dissipation device for the channel cooling section of claim 4, wherein the first side heat sink and the second side heat sink are in “L” shape.

7. The heat dissipation device for the channel cooling section of claim 4, wherein the top heat sink is shaped in a rectangular shape.

8. The heat dissipation device for the channel cooling section of claim 1, wherein the side refractory brick is provided with a stopper on an outer side of the side refractory brick, and the stopper and the side refractory brick form an anti-tipping step.

9. The heat dissipation device for the channel cooling section of claim 4, wherein at least one of the first side heat sink, the second side heat sink, and the top heat sink is provided with a protruding structure at a lower end, and the at least one of the first side heat sink, the second side heat sink, and the top heat sink is fixed in the heat dissipation gaps by the protruding structure.

10. The heat dissipation device for the channel cooling section of claim 9, wherein an outer surface of at least one of the first side refractory brick, the second side refractory brick, and the top refractory brick is provided with an aperture for inserting the protruding structure.

11. A method for using a heat dissipation device for a channel cooling section, wherein the method comprises:
determining installed quantities of first side refractory bricks, second side refractory bricks, top refractory bricks, and bottom supporting refractory bricks, respectively;
assembling, based on the installed quantities, the first side refractory bricks, the second side refractory bricks, the top refractory bricks, and the bottom supporting refractory bricks to form a cavity structure; and
installing at least one heat sink in at least one of a plurality of heat dissipation gaps between the first side refractory bricks, the second side refractory bricks, and the top refractory bricks, respectively.

12. The method of claim 11, wherein the heat dissipation device for the channel cooling section further comprises an automatic installation device, the automatic installation device includes a plurality of manipulators for automatically installing or removing the at least one heat sink, the determining the installed quantities of first side refractory bricks, second side refractory bricks, top refractory bricks, and bottom supporting refractory bricks, respectively further includes:
obtaining user demand data, the user demand data including at least a target temperature of glass liquid;
obtaining production data, lead-out volume data, and processing data;
determining, based on the user demand data, the production data, the lead-out volume data, and the processing data, an installation parameter, wherein the installation parameter includes a first installation parameter and a second installation parameter, the first installation parameter includes the installed quantities of the refractory bricks, and the second installation parameter includes an installed quantity of the heat sink and a heat sink installation distribution.

13. The method of claim 12, wherein the first installation parameter further includes heat dissipation gap widths, intervals of the plurality of heat dissipation gaps, and a count of apertures of the first side refractory bricks, the second side refractory bricks, and the top refractory bricks; the second installation parameter further includes a heat sink thickness and a heat sink type.

14. The method of claim 12, wherein the user demand data further includes a heat dissipation temperature gradient, and the determining installation parameters further comprises:
obtaining a plurality of candidate installation parameters; determining, based on the plurality of candidate installation parameters, processing data, production data, heat dissipation parameters of the heat sink, and production environment data, a heat dissipation feature sequence corresponding to each of the candidate installation parameters by a heat dissipation feature determination model; and
determining, based on the heat dissipation feature sequence and the user demand data, the installation parameters from the plurality of candidate installation parameters.

15. The method of claim 11, wherein the determining the installed quantity of first side refractory bricks, second side refractory bricks, top refractory bricks, and bottom supporting refractory bricks further comprises:
determining the installed quantity based on a thermal efficiency converted from a required power.

16. The method of claim 11, wherein the installing heat sinks in the heat dissipation gap on the first side refractory bricks, the second side refractory bricks, and the top refractory bricks further comprises:
increasing or decreasing the count of heat sinks based on a thermal conductivity need.

17. The method of claim 16, wherein the increasing or decreasing the number of the heat sinks based on the thermal conductivity need further comprises:
obtaining glass liquid temperature data and real-time lead-out volume based on a pipe monitoring device;
determining, based on the glass liquid temperature data, the production environment data, and the real-time lead-out volume, a modified second installation parameter, the modified second installation parameter including a position for mounting or removing the heat sinks and a heat sink type; and
generating a correction instruction based on the corrected second installation parameter, and sending the correction instruction to the automatic installation device to instruct the automatic installation device for controlling the robotic arm to complete installation or removal of the heat sinks.

18. The method of claim 16, wherein the determining the corrected second installation parameter further comprises:
determining, based on an actual installation parameter, actual production environment data, the processing data, the production data, the actual lead-out volume data, and the heat dissipation parameters of the heat sink, a future heat dissipation feature sequence by a heat dissipation feature determination model; and
determining the modified second installation parameter based on the future heat dissipation feature sequence.
